(19) United States
(12) Patent Application Publication
(10) Pub. No.: US 2011/0151414 A1
(43) Pub. Date: Jun. 23, 2011

(54) System for Control and Loss of Fat Weight

(75) Inventors: Michael J. McCarthy, Overland Park, KS (US); John C. Gustin, Carlsbad, CA (US); Mark F. McCarty, San Diego, CA (US)

(73) Assignee: Indices, Inc., Overland Park, KS (US)

(21) Appl. No.: 12/964,981

(22) Filed: Dec. 10, 2010

Related U.S. Application Data
(60) Provisional application No. 61/285,792, filed on Dec. 11, 2009.

(51) Int. Cl. G09B 19/00

(52) U.S. Cl. 434/127

(57) ABSTRACT

The present invention provides a single score (or point value) that can be derived for each foodstuff from the glycemic score (or estimate) and/or the insulin score (or estimate) for the foodstuff combined with one or more macronutrient variables for the foodstuff. This single score, which encompasses many qualities of a foodstuff is called the Smart Score. The Smart Score is useful, for example, because it provides a marker for the relative healthfulness of each foodstuff. The present invention also provides that foodstuffs can be ranked according to the Smart Score for each foodstuff, thereby creating an index. This index is called the Smart Index. The Smart Index is useful, for example, for knowing how one foodstuff compares to another in terms of health benefit or adversity.

### BACKGROUND

The glycemic index is a ranking of carbohydrates according to their affect on blood glucose levels.

The insulin index is a ranking of foodstuffs according to their affect on insulin levels.

The Healthy Eating Index (HEI) was developed by USDA researchers to measure the fit of an individuals diet with the recommendations of the USDA food pyramid.

U.S. Pat. No. 7,523,040 describes a software and hardware system for enabling weight control.

U.S. Pat. No. 7,361,143 describes a weight control system having varying meal plans and meal planning schemes.

U.S. Pat. Nos. 6,878,885, 6,663,564, 6,436,036, and 6,040,531 describe a process for controlling body weight consisting of a points value calculated from an equation that incorporates calories, fat grams, and fibre content factors or terms (each patent is incorporated herein by reference).

### SUMMARY OF THE INVENTION

A diet for losing fat is developed by the inventors which recommends 1) a low-glycemic, 2) low insulin stimulating, 3) protein-rich, 4) low-fat diet which is especially low in 5) saturated fats and 6) trans fats. Additional factors which are considered in certain embodiments include caloric density and fiber content (including soluble and/or insoluble fiber content). Unfortunately, it is difficult for the average person to figure out which foodstuffs to eat on the diet because there are so many foodstuff variables to consider.

The inventors discovered that a single score (or point value) can be derived for each foodstuff from the glycemic score (or estimate) and/or the insulin score (or estimate) for the foodstuff combined with one or more macronutrient variables for the foodstuff. The inventors call this single score, which encompasses many qualities of a foodstuff, the Smart Score. The Smart Score is useful, for example, because it provides a marker for the relative healthfulness of each foodstuff.

The inventors also discovered that foodstuffs can be ranked according to the Smart Score for each foodstuff, thereby creating an index. The inventors call this index the Smart Index. The Smart Index is useful, for example, for knowing how one foodstuff compares to another in terms of health benefit or adversity.

In view of the present invention, a dieter only needs to know or look up one Smart Score for a foodstuff to determine if that foodstuff is conducive to the diet of interest. In one example, the Smart Score and a Smart Index can be determined for two or more, or all, of the variables listed above and can, also, be generalized to other diets of interest. In certain embodiments, additional food factors can be included in the Smart Score and Smart Index (e.g., fibre content and/or calories and/or caloric density of foodstuffs). In one embodiment, the inventors are also interested in a diet similar to the above, however, it is not protein-rich (instead this second diet focuses on low-glycemic carbohydrates). Accordingly, the equation, see below, for the indexing score (the Smart Score) can be modified such that it does not weigh as strongly for protein-rich foodstuffs. In another embodiment, the inventors have discovered that a term for caloric density of each foodstuff is useful in calculating the Smart Score and Smart Index. The caloric density factor is particularly important for separating out “empty calorie” foodstuffs such as sugar sodas as unhealthy food alternatives.

One embodiment of the present invention provides an index, comprising: a ranking of foodstuffs ranked according to a score for each foodstuff, wherein the score is calculated by an equation that includes a first component which includes one or more of a glycemic score and an insulin score and a second component which includes one or more of a fat score and a protein score. In one embodiment, the equation further includes a term for a caloric density score. In anther embodiment, the equation includes a glycemic score and one or more of a fat score and a protein score and optionally, a caloric density score. In still anther embodiment, the equation further includes an insulin score and, optionally, a caloric density score.

In a further embodiment, the invention provides a smart score, comprising: an outcome calculated using an equation including a first component which includes one or more of a glycemic score and an insulin score and second component which includes one or more of a fat score and a protein score. In one embodiment, the equation further includes a caloric density score. In another embodiment, the equation includes a glycemic score and one or more of a fat score and a protein score and, optionally, a caloric density score. In the same embodiment, the equation, optionally, further includes an insulin score and further, optionally, includes a caloric density score.

A further embodiment of the present invention provides a method of ranking a list foodstuffs, thereby transforming the list into an index, comprising: calculating a ranking score for each foodstuff and sorting the list of foodstuffs according to the ranking score; wherein the calculating step is performed according to an equation which includes a first component which includes one or more of a glycemic score and an insulin score and second component which includes one or more of a fat score and a protein score. In one embodiment, the equation further includes a third component which includes a caloric density score. In another embodiment, the equation includes a first term including a glycemic score and a second term including one or more of a fat score and a protein score. In another embodiment, the equation further includes a third term for a caloric density score. In still another embodiment, the equation further includes a third term for an insulin score and, optionally, includes a term for a caloric density score.

One embodiment of the present invention provides a process for reducing body weight in a human being comprising the steps of: determining (e.g., calculating or looking up in an index) a smart score for foodstuffs being considered for consumption and consuming the foodstuffs with a relatively low smart score (e.g., 0-75 or 0-50 preferred).

Another embodiment of the present invention provides a process for reducing body weight (preferably fat weight), comprising: the steps of: (a) determining a smart score for each foodstuff that is under consideration for consumption (b) calculating a maximum number of smart score points allotted per day (24 hour period) based on current body weight, caloric reduction to be achieved, physical activity level (optionally), and physical activity duration (optionally); (c) during a day, selecting and ingesting food servings having a total point value less than or equal to the calculated maximum; and (d) repeating at least steps (b) and (c) on successive days until the desired weight reduction is achieved.

One embodiment of the present invention provides, a process for weight control (preferably fat weight loss and/or control) comprising the steps of: determining a numerical smart score for candidate food servings for a day's menu; determining a maximum daily smart score total appropriate to produce a restricted daily energy intake based on the current weight of the individual; optionally adjusting the maximum smart score total upwardly for physical activity during the day; and ingesting the food servings corresponding to a total lying at or below said determined maximum.

In one embodiment, the invention provides a process for losing fat weight in a non-therapeutic regimen.

In another embodiment, the invention provides for the therapeutic reduction in fat weight of an animal, preferably a human.

It is a surprising discovery of the present invention that numerous formulae can be used to transform the glycemic index and/or the insulin index scores and one or more macronutrient quantities of foodstuff into a useful Smart Score and, optionally, a useful Smart Index. Therefore, certain embodiments of the present invention provide formulae that are useful for derivation of the Smart Score and Smart Index.

### DETAILED DESCRIPTION

### Terminology

In the present invention, the indexing score may be referred to as a Smart Score and the index resulting from ranking foodstuffs according to their Smart Score, may be referred to as the Smart Index.

The term “foodstuff,” as used herein, means a food and/or a beverage for consumption by an animal, preferably a human.

One embodiment provides a formula in the following form:

SS=GS+F/k₁+kcal/k₂−P/k₃, (Formula I)

wherein SS is the Smart Score for a foodstuff, GS is the glycemic index score for the foodstuff, f is the amount of fat in grams per 100 g of the foodstuff, kcal is the amount of kcal per 100 grams of the foodstuff, p is the amount of protein in grams per 100 grams of the foodstuff and k₁, k₂, and k₃ are constants. The constant k1 preferably has a value of 0.1 to 10, most preferably approximately 0.5. The constant k2 preferably has a value of 0.1 to 100, most preferably approximately 10. The constant k3 preferably has a value of 0.1 and 10, most preferably approximately 0.5. In view of the present invention, it is understood that in different embodiments, a term for insulin index score (IS) can be added to the above formula (preferably GS and IS are averaged or given a weighted average (e.g., (GI+3*II)/4); the GI can be replaced by II; the term “f” can be substituted or combined with terms for saturated fat (SF), and/or trans fat (TF); the term for kcal can be eliminated; the term for protein (P) can be eliminated; or both kcal and protein terms can be eliminated.

The preferred form of formula I is:

SS=(GS+3IS)/4+(Total Fat+Saturated Fat+Trans Fat)/3+kcal/10−p/0.5. (Formula II)

Because the insulin score (IS) is known for relatively few foodstuffs, it is understood in the present invention that the term for IS is eliminated from the equation when IS is not known. Alternatively, the IS is set equal to the GI for any foodstuff for which the IS is not known.

Table I, below, provides a Smart Index (the first two columns of foodstuff and Smart Score are the Smart Index) which is a ranking of foodstuffs according to each Smart Score. The Smart Scores in Table I, below, are calculated using the following formula:

Int((Glycemic Index+3*Insulin Index)/4*(1+1*Fat*9/Calories+2*Saturated Fat*9/Calories+5*Trans Fat*9/Calories)*(1+((Calories−Protein*4)/(Serving grams−Protein)−1.3)/4)/(1+Protein*4/Calories)) (Formula III).

TABLE I

| | Smart | Glycemic | Insulin | kilo | Fat | Sat | Trans | |
|---|---|---|---|---|---|---|---|---|
| Foodstuff | Score | Score | Score | calories | (total) | Fat | Fat | Protein |
| Egg Whites, From 3 | 9 | 9 | 31 | 48 | 0.17 | 0 | 0 | 10.90 |
| Large Eggs | | | | | | | | |
| Chicken Breast, | 15 | 25 | 25 | 165 | 3.57 | 1.01 | 0 | 31.02 |
| Roasted, without Skin | | | | | | | | |
| Barley | 20 | 22 | 22 | 123 | 0.44 | 0.093 | 0 | 2.26 |
| Peach, Fresh | 20 | 28 | 28 | 39 | 0.25 | 0.028 | 0 | 0.91 |
| Halibut, Cooked with | 28 | 28 | 59 | 140 | 2.94 | 0.417 | 0 | 26.69 |
| Dry Heat | | | | | | | | |
| Carrots, Baby, Raw | 30 | 41 | 41 | 35 | 0.13 | 0.023 | 0 | 0.64 |
| Pinto Beans (Dried and | 31 | 39 | 39 | 143 | 0.65 | 0.136 | 0 | 9.01 |
| Boiled, without salt) | | | | | | | | |
| Kidney Beans (Dried | 33 | 44 | 44 | 127 | 0.5 | 0.072 | 0 | 8.67 |
| and Boiled, no salt) | | | | | | | | |
| Kidney Beans | 36 | 52 | 52 | 84 | 0.36 | 0.085 | 0 | 5.26 |
| Strawberries, Fresh | 36 | 40 | 40 | 69 | 0.6 | 0.172 | 0 | 0.58 |
| Steel-Cut Oats | 37 | 52 | 40 | 150 | 2.5 | 0.5 | 0 | 5 |
| 100% Whey Protein Drink | 38 | 33 | 140 | 200 | 0 | 0 | 0 | 50 |
| reconstituted in water | | | | | | | | |
| Spaghetti, Cooked 5 | 40 | 40 | 42 | 158 | 0.93 | 0.176 | 0 | 5.8 |
| minutes | | | | | | | | |
| Beef, Ground 5% | 41 | 21 | 51 | 171 | 6.56 | 2.977 | 0.167 | 26.29 |
| Fat, Cooked, Broiled | | | | | | | | |
| Cheese, Very Low-Fat | 41 | 55 | 45 | 179 | 5.1 | 3.304 | 0 | 28.4 |
| Orange (Large | 42 | 48 | 60 | 86 | 0.22 | 0.028 | 0 | 1.73 |
| 3 1/16″ Diameter) | | | | | | | | |
| All-Bran | 43 | 40 | 32 | 81 | 1.52 | 0.195 | 0 | 4.07 |
| Apple (Medium Size | 44 | 40 | 59 | 95 | 0.31 | 0.051 | 0 | 0.47 |
| 3″ Diameter) | | | | | | | | |
| Rolled Oats (Cooked | 45 | 82 | 40 | 170 | 2.83 | 0.697 | 0.052 | 5.76 |
| in Microwave) | | | | | | | | |
| Soy Milk | 46 | 55 | 55 | 43 | 1.47 | 0.205 | 0 | 2.6 |
| Beef, Extra Lean | 47 | 21 | 51 | 211 | 9.26 | 3.54 | 0 | 29.88 |
| Coca-Cola Classic | 48 | 63 | 63 | 182 | 0.1 | 0 | 0 | 0.34 |
| Eggs, Hardboiled, 2 | 49 | 42 | 31 | 155 | 10.61 | 3.267 | 0 | 12.58 |
| Large | | | | | | | | |
| Sweet Potato, Baked | 50 | 35 | 70 | 90 | 0.15 | 0.034 | 0 | 2.01 |
| Omelet, Large | 59 | 42 | 31 | 157 | 12.03 | 3.296 | 0.677 | 10.59 |
| Rice, Brown, medium- | 59 | 66 | 62 | 112 | 0.83 | 0.165 | 0 | 2.32 |
| grained, Cooked | | | | | | | | |
| Eggs, Fried, 2 large | 60 | 42 | 31 | 196 | 15.31 | 4.294 | 0 | 13.63 |
| Grapes, Fresh | 62 | 43 | 82 | 67 | 0.35 | 0.114 | 0 | 0.63 |
| Banana | 65 | 48 | 81 | 89 | 0.33 | 0.112 | 0 | 1.09 |
| Fried Chicken (With | 68 | 46 | 46 | 260 | 13.2 | 3.52 | | 24.84 |
| Skin, With Batter) | | | | | | | | |
| Peanuts, Dry- | 69 | 12 | 20 | 585 | 49.66 | 6.893 | 0 | 23.68 |
| Roasted, with Salt | | | | | | | | |
| Rice, White, Medium- | 70 | 65 | 79 | 130 | 0.21 | 0.057 | 0 | 2.38 |
| Grained, Cooked | | | | | | | | |
| Milk, Non-Fat, 1 Cup | 72 | 46 | 140 | 83 | 0.2 | 0.126 | 0 | 5 |
| Avocado | 74 | 35 | 35 | 167 | 15.41 | 2.126 | 0 | 1.96 |
| Watermelon, Fresh | 74 | 76 | 76 | 127 | 0.15 | 0 | 0 | 0.61 |
| Rye Bread, 1 Slice | 75 | 60 | 56 | 83 | 1.06 | 0.2 | 0 | 2.72 |
| Beef, Lean 20% Fat | 78 | 21 | 51 | 291 | 19.71 | 3.77 | 0.2 | 26.42 |
| Beef, Marbled, 30% | 88 | 21 | 51 | 273 | 18.21 | 7.329 | 0.891 | 25.38 |
| Fat, Cooked, Broiled | | | | | | | | |
| Potato, Baked with | 123 | 103 | 121 | 198 | 0.1 | 0.026 | 0 | 4.29 |
| Skin | | | | | | | | |
| White Bread | 129 | 80 | 100 | 266 | 3.29 | 0.717 | | 7.64 |
| Milk, Whole (3.25% | 160 | 57 | 140 | 146 | 7.93 | 4.551 | 0 | 7.86 |
| Fat), 1 cup | | | | | | | | |
| French Fries, Medium | 184 | 110 | 74 | 370 | 18.86 | 2.438 | 0.153 | 4.46 |
| Jelly Beans | 241 | 118 | 160 | 375 | 0.05 | 0 | 0 | 0 |

One embodiment provides a formula in the following form:

Smart Index (SS)=Int((Glycemic Score+3*Insulin Score)/4*(1+k1*(Fat*900/Calories+Saturated Fat*900/Calories+Trans Fat*900/Calories−k2)/k3)*(1+((Calories−Protein*3)/Serving grams−k4)/3)/(1+(Protein*300/Calories−k5)/k6)). (Formula IV)

wherein
SS is the Smart Score for a foodstuff,
GS is the glycemic score for the foodstuff,
IS is the insulin score for the foodstuff,
Fat is the amount of grams of fat per 100 grams of foodstuff,
Saturated Fat is the amount of grams of saturated fat per 100 grams of foodstuff,
Trans Fat is the amount of grams of trans fat per 100 grams of foodstuff,
Calories is the amount of kilocalories per 100 grams of foodstuff,
Protein is the amount of grams of protein per 100 grams of foodstuff;
Serving grams is the amount of grams per serving (e.g., 100); and.
k1, k2, k3, k4, k5, and k6 are constants.
The constant k1 is preferably in the range of 3 to 10, most preferably about 3.
The constant k2 is preferably in the range of 5 to 20, preferably about 10.
The constant k3 is preferably in the range of 80 to 95, preferably about 90.
The equation k2+k3=100 is preferably true.
The constant k4 is preferably in the range of 1 to 5, most preferably 1.34.
The constant k5 is preferably in the range of 5 to 20, preferably about 15.
The constant k6 is preferably in the range of 80 to 95, preferably about 85.
The equation k5+k6=100 is preferably true.
The preferred form of formula IV is:

Smart Index (SS)=Int((Glycemic Score+3*Insulin Score)/4*(1+3*(Fat*900/Calories+Saturated Fat*900/Calories+Trans Fat*900/Calories−10)/90)*(1+((Calories−Protein*3)/Serving grams−1.34)/3)/(1+(Protein*300/Calories−15)/85)). (Formula V)

Again, in view of the present invention, numerous formulae can be constructed to derive a useful Smart Score, including the examples, above. Therefore it is a general principle of the present invention that the Smart Score can be derived by combining one or more of a glycemic score and an insulin score with one or more of a fat factor, a protein factor, and a caloric factor. In certain embodiments, the fat factor may be expanded to include total fat, saturated fat, and/or trans fat factors. In certain embodiments, a fibre factor is included in the derivation.

Table II, below, provides a Smart Index (the first two columns of foodstuff and Smart Score are the Smart Index) which is a ranking of foodstuffs according to each Smart Score. The Smart Scores in Table II, below, are calculated using Formula V.

TABLE II

| | Smart | Glycemic | Insulin | | | Saturated | Trans | |
|---|---|---|---|---|---|---|---|---|
| Foodstuff | Score | Score | Score | kcal | Fat | Fat | Fat | Protein |
| Egg Whites, From 3 | 7 | 9 | 31 | 48 | 0.17 | 0 | 0 | 10.90 |
| Large Eggs | | | | | | | | |
| Barley | 18 | 22 | 22 | 123 | 0.44 | 0.093 | 0 | 2.26 |
| Peach, Fresh | 18 | 28 | 28 | 39 | 0.25 | 0.028 | 0 | 0.91 |
| Chicken Breast, | 19 | 25 | 25 | 165 | 3.57 | 1.01 | 0 | 31.02 |
| Roasted, without Skin | | | | | | | | |
| Carrots, Baby, Raw | 24 | 41 | 41 | 35 | 0.13 | 0.023 | 0 | 0.64 |
| Kidney Beans (Dried | 29 | 44 | 44 | 127 | 0.5 | 0.072 | 0 | 8.67 |
| and Boiled, no salt) | | | | | | | | |
| Pinto Beans (Dried and | 29 | 39 | 39 | 143 | 0.65 | 0.136 | 0 | 9.01 |
| Boiled, without salt) | | | | | | | | |
| 100% Whey Protein Drink | 31 | 33 | 140 | 200 | 0 | 0 | 0 | 50 |
| reconstituted in water | | | | | | | | |
| Kidney Beans | 32 | 52 | 52 | 84 | 0.36 | 0.085 | 0 | 5.26 |
| Orange (Large 3 1/16″ | 33 | 48 | 60 | 86 | 0.22 | 0.028 | 0 | 1.73 |
| Diameter) | | | | | | | | |
| Coca-Cola Classic | 35 | 63 | 63 | 182 | 0.1 | 0 | 0 | 0.34 |
| Halibut, Cooked with | 35 | 28 | 59 | 140 | 2.94 | 0.417 | 0 | 26.69 |
| Dry Heat | | | | | | | | |
| Apple (Medium Size | 36 | 40 | 59 | 95 | 0.31 | 0.051 | 0 | 0.47 |
| 3″ Diameter) | | | | | | | | |
| Strawberries, Fresh | 36 | 40 | 40 | 69 | 0.6 | 0.172 | 0 | 0.58 |
| Spaghetti, Cooked 5 | 39 | 40 | 42 | 158 | 0.93 | 0.176 | 0 | 5.8 |
| minutes | | | | | | | | |
| Sweet Potato, Baked | 41 | 35 | 70 | 90 | 0.15 | 0.034 | 0 | 2.01 |
| Steel-Cut Oats | 42 | 52 | 40 | 150 | 2.5 | 0.5 | 0 | 5 |
| Rolled Oats (Cooked | 52 | 82 | 40 | 170 | 2.83 | 0.697 | 0.052 | 5.76 |
| in Microwave) | | | | | | | | |
| Milk, Non-Fat, 1 Cup | 56 | 46 | 140 | 83 | 0.2 | 0.126 | 0 | 5 |
| Grapes, Fresh | 56 | 43 | 82 | 67 | 0.35 | 0.114 | 0 | 0.63 |
| All-Bran | 57 | 40 | 32 | 81 | 1.52 | 0.195 | 0 | 4.07 |
| Banana | 57 | 48 | 81 | 89 | 0.33 | 0.112 | 0 | 1.09 |
| Rice, Brown, medium- | 59 | 66 | 62 | 112 | 0.83 | 0.165 | 0 | 2.32 |
| grained, Cooked | | | | | | | | |
| Rice, White, Medium- | 59 | 65 | 79 | 130 | 0.21 | 0.057 | 0 | 2.38 |
| Grained, Cooked | | | | | | | | |
| Watermelon, Fresh | 61 | 76 | 76 | 127 | 0.15 | 0 | 0 | 0.61 |
| Cheese, Very Low-Fat | 61 | 55 | 45 | 179 | 5.1 | 3.304 | 0 | 28.4 |
| Beef, Ground 5% Fat, | 64 | 21 | 51 | 171 | 6.56 | 2.977 | 0.167 | 26.29 |
| Cooked, Broiled | | | | | | | | |
| Soy Milk | 65 | 55 | 55 | 43 | 1.47 | 0.205 | 0 | 2.6 |
| Beef, Extra Lean | 78 | 21 | 51 | 211 | 9.26 | 3.54 | 0 | 29.88 |
| Rye Bread, 1 Slice | 90 | 60 | 56 | 83 | 1.06 | 0.2 | 0 | 2.72 |
| Eggs, Hardboiled, 2 | 96 | 42 | 31 | 155 | 10.61 | 3.267 | 0 | 12.58 |
| Large | | | | | | | | |
| Potato, Baked with | 103 | 103 | 121 | 198 | 0.1 | 0.026 | 0 | 4.29 |
| Skin | | | | | | | | |
| Omelet, Large | 114 | 42 | 31 | 157 | 12.03 | 3.296 | 0.677 | 10.59 |
| Fried Chicken (With | 120 | 46 | 46 | 260 | 13.2 | 3.52 | | 24.84 |
| Skin, With Batter) | | | | | | | | |
| Eggs, Fried, 2 large | 123 | 42 | 31 | 196 | 15.31 | 4.294 | 0 | 13.63 |
| Beef, Lean 20% Fat | 148 | 21 | 51 | 291 | 19.71 | 3.77 | 0.2 | 26.42 |
| Peanuts, Dry- | 150 | 12 | 20 | 585 | 49.66 | 6.893 | 0 | 23.68 |
| Roasted, with Salt | | | | | | | | |
| White Bread | 156 | 80 | 100 | 266 | 3.29 | 0.717 | | 7.64 |
| Beef, Marbled, 30% | 163 | 21 | 51 | 273 | 18.21 | 7.329 | 0.891 | 25.38 |
| Fat, Cooked, Broiled | | | | | | | | |
| Avocado | 168 | 35 | 35 | 167 | 15.41 | 2.126 | 0 | 1.96 |
| Jelly Beans | 219 | 118 | 160 | 375 | 0.05 | 0 | 0 | 0 |
| Milk, Whole (3.25% | 273 | 57 | 140 | 146 | 7.93 | 4.551 | 0 | 7.86 |
| Fat), 1 cup | | | | | | | | |
| French Fries, Medium | 361 | 110 | 74 | 370 | 18.86 | 2.438 | 0.153 | 4.46 |

In certain embodiments related to fat loss and/or control, the summation of Smart Scores for a day's foodstuffs is limited by body weight and, optionally, physical activity (which includes physical activity level and duration). For example, the following formula can be used to calculate the maximum daily Smart Score.

Summation SS_{day}=c₁*body weight (kg)*minutes of activity, (Formula VI)

where Summation SS_{day} is the summation of the smart scores of foodstuffs consumed in one day, and
c₁ is a constant that is from 0.1 to 10 (preferably, 0.5 to 2, and more preferably about 0.7).

What is claimed is:

1. An index, comprising: a ranking of foodstuffs wherein the foodstuffs are ranked according to a score for each foodstuff, wherein the score is calculated by an equation that includes a first component which includes one or more of a glycemic score and an insulin score and a second component which includes one or more of a fat score and a protein score.

2. The index of claim 1, wherein the equation further includes a term for a caloric density score.

3. The index of claim 1, wherein the equation includes a glycemic score, a fat score, and a protein score.

4. The index of claim 3, wherein the equation further includes an insulin score.

5. The index of claim 3, wherein the fat score includes one or more of a total fat term, a saturated fat term or a trans fat term.

6. A system for calculating a smart score, comprising: an outcome calculated using an equation including a first component which includes one or more of a glycemic score and an insulin score and second component which includes one or more of a fat score and a protein score.

7. The smart index score of claim 6, wherein the equation further includes a caloric density score.

8. The smart index score of claim 6, wherein the equation includes a glycemic score, a fat score, and a protein score.

9. The smart index score of claim 8, wherein the equation further includes an insulin score.

10. The smart index score of claim 8, wherein the fat index score includes one or more of a total fat term, a saturated fat term or a trans fat term.

11. A method of ranking a list of foodstuffs, comprising: calculating a ranking score for each foodstuff and sorting the list of foodstuffs according to the ranking score; wherein the calculating step is performed according to an equation which includes a first component which includes one or more of a glycemic score and an insulin score and second component which includes one or more of a fat score and a protein score.

12. The method of claim 11, wherein the equation further includes a caloric density score.

13. The method of claim 11, wherein the equation includes a glycemic score and one or more of a fat score and a protein score.

14. The method of claim 13, wherein the equation includes an insulin score.

15. The method of claim 11, the equation includes the fat score, and wherein the fat score includes one or more of a term for total fat, a term for saturated fat or a term for trans fat.
